(19) United States
(12) Patent Application Publication
(10) Pub. No.: US 2011/0106636 A1
(43) Pub. Date: May 5, 2011

(54) METHOD AND SYSTEM FOR MANAGING ONLINE PRESENCE

(75) Inventors: Josh Spear, Bantam, CT (US); Aaron Dignan, New York, NY (US); Robert Schuham, Boulder, CO (US); Jordan Berkowitz, Brooklyn, NY (US)

(73) Assignee: UNDERCURRENT INC., New York, NY (US)

(21) Appl. No.: 12/938,096

(22) Filed: Nov. 2, 2010

Related U.S. Application Data
(60) Provisional application No. 61/257,325, filed on Nov. 2, 2009.

(51) Int. Cl. G06Q 30/00

(52) U.S. Cl. 705/14.73

(57) ABSTRACT

In a method and system for managing an online presence of a brand or product, providing a graphic representation of (i) a plurality of nodes, each node signifying (a) an instance of an online advertisement, (b) a general venue of a series of marketing tactics, (c) a representation of an advertising or marketing agency, and/or (d) a sales/sales fulfillment site, and (ii) at least one connection, each connection linking a pair of nodes, the connection signifying an informational relationship between the pair of nodes, the informational relationship being a logical and/or a communicative relationship.

### CROSS-REFERENCE TO RELATED APPLICATIONS

The present application claims the benefit of U.S. Provisional Application Ser. No. 61/257,325 filed 2 Nov. 2009; which is incorporated herein by reference in its entirety.

### FIELD OF THE INVENTION

The present invention relates to review, evaluation and management of an online presence, in particular to systems and methods for reviewing, evaluating and managing an online marketing presence of a brand or product.

### BACKGROUND

The rapid growth in the importance of online marketing, and the proliferation of disparate online venues in which marketing may be carried out, has exacerbated deficiencies in existing management tools that were developed for more traditional media. A robust online marketing presence is now vital to the successful deployment of a new brand or product, and to sustaining and enhancing revenues from existing ones. Successful management of an online marketing presence requires an organization to coordinate its online marketing strategies and tactics with those it employs in traditional media, while accommodating the rapid dynamics, immense size, and diverse nature of the online environment.

The size and diversity of the online marketing audience, and the variety of venues in which a brand's online presence, including the execution of specific campaigns and activities, such as, for example, a marketing campaign, may choose to engage (or find itself engaged irrespective of choice) cannot be overstated. Some of these venues will be (at least largely) under the control of the proprietor of the brand or product. For example, a launch of a television program, movie, or video game will often be preceded by a website directed toward attracting attention of prospective viewers and fans. The website will often be linked in a complex manner to affiliated sites. For example a web site promoting a new television show may provide links to the producing studio, to the network on which the show will be available, to actors' and other artists' personal websites, to sponsoring advertisers' web pages, etc.

Other venues will be (at least largely) out of the direct control of the proprietor, but nevertheless of intense interest. For example, emerging online social media resources such as Facebook, YouTube, and Twitter are now important venues for a brand's online presence, including the execution of specific campaigns and activities, such as, for example, an online marketing campaign. Virtual spaces such as Facebook, YouTube, blogs, wikis, discussion boards, and the like are other examples of online marketing environments. These venues, likewise, have complex and dynamic linkages with each other and with a proprietor's own websites.

Thus, there is a need for improved methods and systems for managing an online marketing presence of a brand or product.

### SUMMARY OF THE INVENTION

The methods and systems disclosed herein provide improved, semi-automated techniques for reviewing, evaluating, planning and managing the digital footprint of a brand or product, including a brand's online presence, and for execution of specific campaigns and activities. In an embodiment, an interactive tool is provided, by which a marketing campaign may be planned and managed.

In an embodiment, the presence of a product or brand across a disparate variety of venues, such as internet sites and/or other market and media locations, may be planned, reviewed, evaluated and managed using the interactive tool. The execution of specific campaigns and activities may be enhanced and better enabled, through the control provided by the tool. The tool may enable a user to monitor and manipulate linkages and relationships between these disparate venues by associating a logical “node” with each venue of interest, and representing a linkage or relationship between two nodes as a “connection.” Each node may signify, for example, an instance of an online advertisement, a representation of an advertising or marketing agency, and/or a sales/sales fulfillment site. A node may also signify a general venue of one or more series of marketing tactics employed online and/or on mobile devices (e.g., Facebook, Twitter, YouTube) where a “marketing tactic” may consist of a specific execution associated with a marketing initiative, usually derived from a brand strategy. As an example, if a company's marketing initiative, as part of its brand strategy, is to maximize viewing of a released piece of video, the specific execution of that initiative might be to maximize the number of video distribution platforms on which the video would be played, each of which might be represented by a node. Each connection between two nodes may signify an informational relationship between the pair of nodes such as a logical and/or a communicative relationship.

An output of the interactive tool may be a graphical representation (which may also be referred to hereinafter as a “map”) of a more or less complex network of nodes and connections. The map provides a visual depiction of the online presence of the product or brand.

The tool may be a software application hosted on a remote web server accessible via http/https. Through the use of Flash, PHP, Apache, and MYSQL, for example a user may be served this application on one or more remote terminals capable of accessing the Internet via a standard web browser application.

In a further embodiment, a convenient user interface may provide an intuitive representation of network relationships, such that a map-like visualization of the marketing plan indicating relationships between a complex network of nodes.

In yet another embodiment, characteristics of the connections between nodes may be selected to represent a volume of “hits,” indicating click-through traffic or a measure of financial performance, for example.

In an embodiment, real-time data on marketing network performance may be collected and interactively displayed.

### BRIEF DESCRIPTION OF THE DRAWINGS

Embodiments are illustrated by way of example, and not limitation, in the figures of the accompanying drawings, in which:

FIG. 1 illustrates an exemplary system embodiment.

FIG. 2A is a diagram illustrating an exemplary connection between two nodes.

FIG. 2B is a diagram illustrating a network diagram that may be produced by an embodiment.

FIG. 3 illustrates exemplary features and functions associated with a toolbox display, consistent with an embodiment.

FIG. 4 illustrates a menu display, consistent with an embodiment.

### DETAILED DESCRIPTION

Described herein are systems and methods for reviewing, evaluating, planning and managing the digital footprint of a brand or product, including a brand's online presence, and for execution of specific campaigns and activities.

In an embodiment, an online software as a service tool is provided for creating visual and informational representations of the relationship between the venues where a brand or brand family has (or plans to develop) a traditional and digital footprint, including, for example, a marketing presence. The venues may include traditional print, radio, television, video games and electronic media, in addition to venues accessible only over the Internet or by way of mobile devices. The tool may allow a user to graphically represent the complexity of a brand's digital footprint or presence through, for example, use of variously styled shapes (nodes) and lines (connections). A rich diversity of information may be presented, and the user's experience and efficiency enhanced, by representing the nodes and lines with a variety of stylings, including, for example, size, color, shape, crosshatching, font size, etc., each of which styling being associated with a particular type of information. For example, a gradation in node size may be used to illustrate a gradation in the strength, volume or value of a particular venue. As a further example a gradation in connection thickness may illustrate the volume of “click-through” traffic or an indicator of sales realization rates.

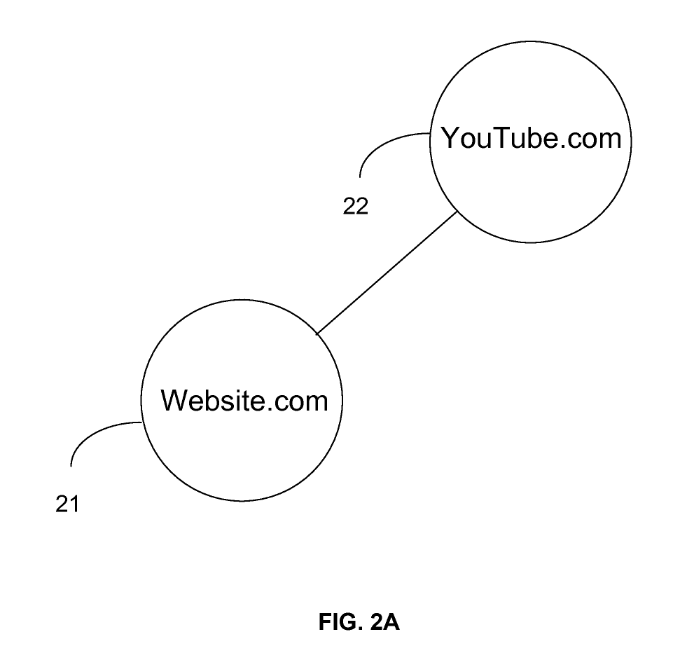

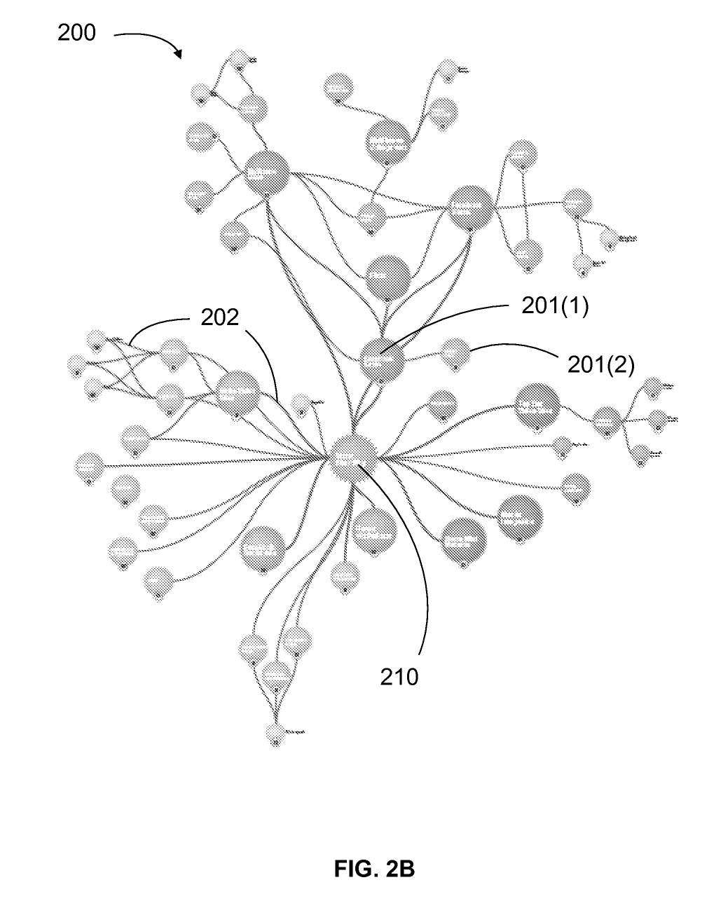

In a simple example, illustrated in FIG. 2A, a map may have as few as two nodes: for example, a central node 21 labeled Website.com and a second node 22 labeled YouTube.com. The relationship between these two nodes may then be represented by connecting the two with a line. The connection may indicate, for example, that a consumer could follow online links or graphics from one node to the other. In actual practice, it is anticipated that several tens or hundreds of nodes and connections, with a complex interrelationship, may advantageously be used to illustrate, plan and manage a typical national or global online marketing plan.

Many additional pieces of information may also be advantageously managed with the present techniques. In an embodiment, for example, information may be associated with each node, at least some of which may be normally hidden until the node is selected. For example, each node may include information such as title, URL, importance, phase, frequency of update, description, agency, account holder, contact information, login information, and information regarding connections and strength of connections.

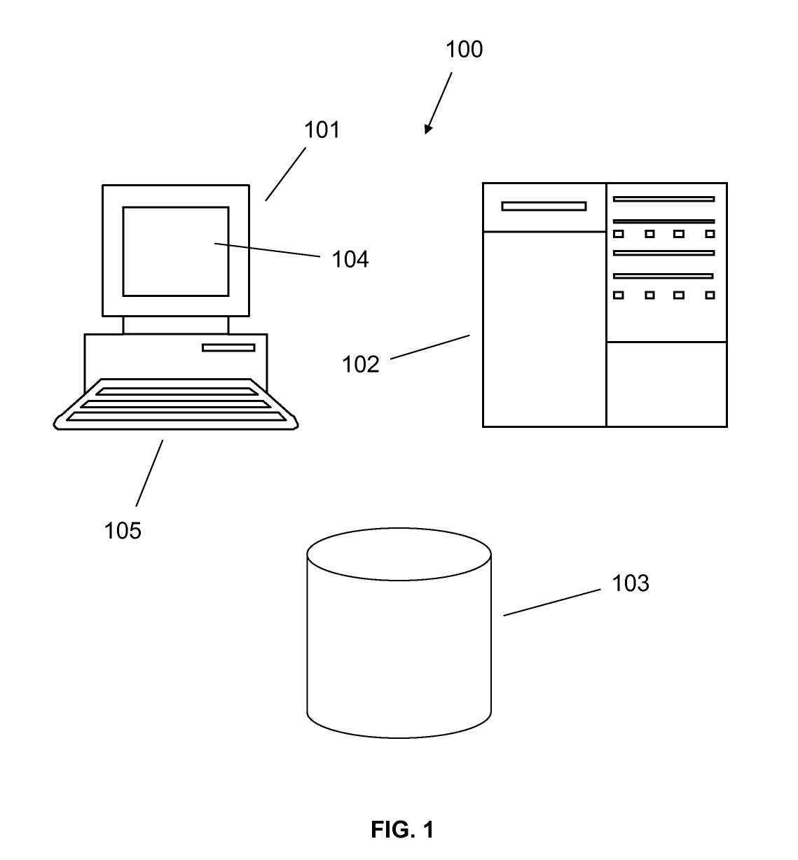

Referring now to FIG. 1, a system embodiment will be described. The system 100 may consist of a computerized workstation 101 having, for example, a processor 102, a memory 103, a display 104, and a user input interface 105. Memory 103 may consist of a computer readable storage medium, such as, but not limited to, any type of disk including floppy disks, optical disks, CD-ROMs, and magnetic-optical disks, read-only memories (ROMs), flash drives, random access memories (RAMs), EPROMs, EEPROMs, magnetic or optical cards, or any type of tangible media suitable for storing electronic instructions.

System 100 also consists of a software application (not shown), operable with workstation 101. The software application provides a user an interactive tool wherewith the user may graphically represent (a) two or more nodes, each node signifying an instance of an online advertisement, the general venue of a series of marketing tactics, a representation of an advertising or marketing agency, and/or a sales/sales fulfillment site; and (b) at least one connection, each connection linking a pair of nodes, the connection signifying an informational relationship between the pair of nodes such as a logical relationship and/or a communicative relationship. The software application causes workstation 101 to graphically display the nodes and connections. The graphical representation may be accomplished by a Flash application that interprets database entries that define and assign properties to nodes, and renders the nodes graphically according to a set of graphical rules defined in a presentation layer.

A user of workstation 101, having logged into the system, may be presented with options of viewing and/or editing an existing map, or creating a new map using display 104 and user input interface 105. By using a menu driven command interface, for example, the user may be given command options such as “New Node,” “Move Node” and “Node Settings,” the user may, for example, create nodes for various elements in a marketing program, relocate existing nodes, label the nodes, associate additional information with one or more nodes, and set parameters for how the nodes connect to each other. The user may name or rename the map and share it with others.

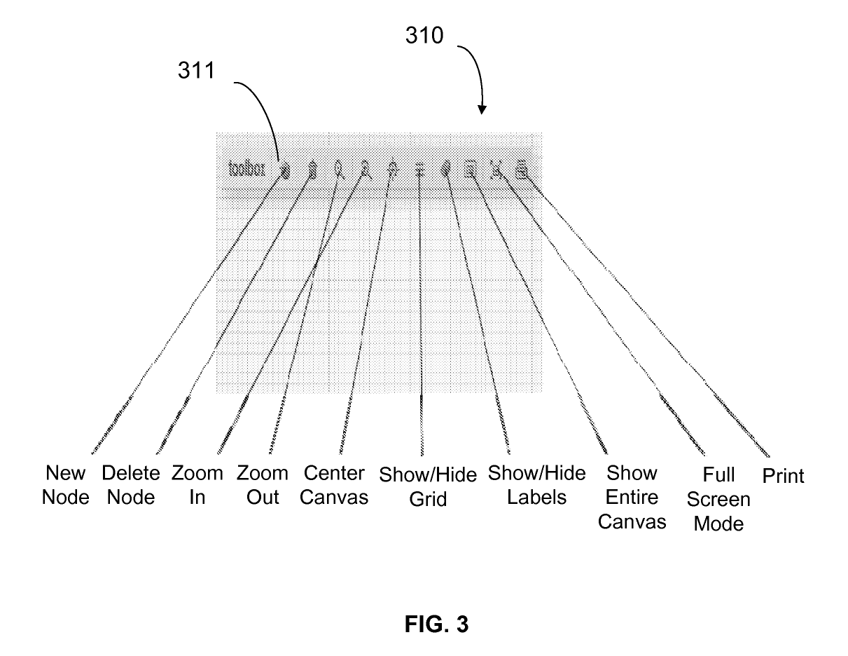

Conveniently, a graphical user interface may be provided to enable the user to access a suite of customizable tools to efficiently accomplish the foregoing. Referring now to FIG. 3, node creation may, for example, be accomplished by selecting an associated tool 311 from tool bar 310 and then clicking on a “canvas” to create a new node. The “canvas”, in this context, represents a virtual drawing sheet or other medium that registers and displays the graphical representation.

The user may be enabled to move or otherwise arrange nodes by way of a conventional drag and drop operation. Connections, labels, and other node options may be configured by the user via a graphical user interface (GUI). Conveniently, the GUI may be accessed through a control panel that may be viewable on display 104 as an overlay on the canvas or separated from the canvas.

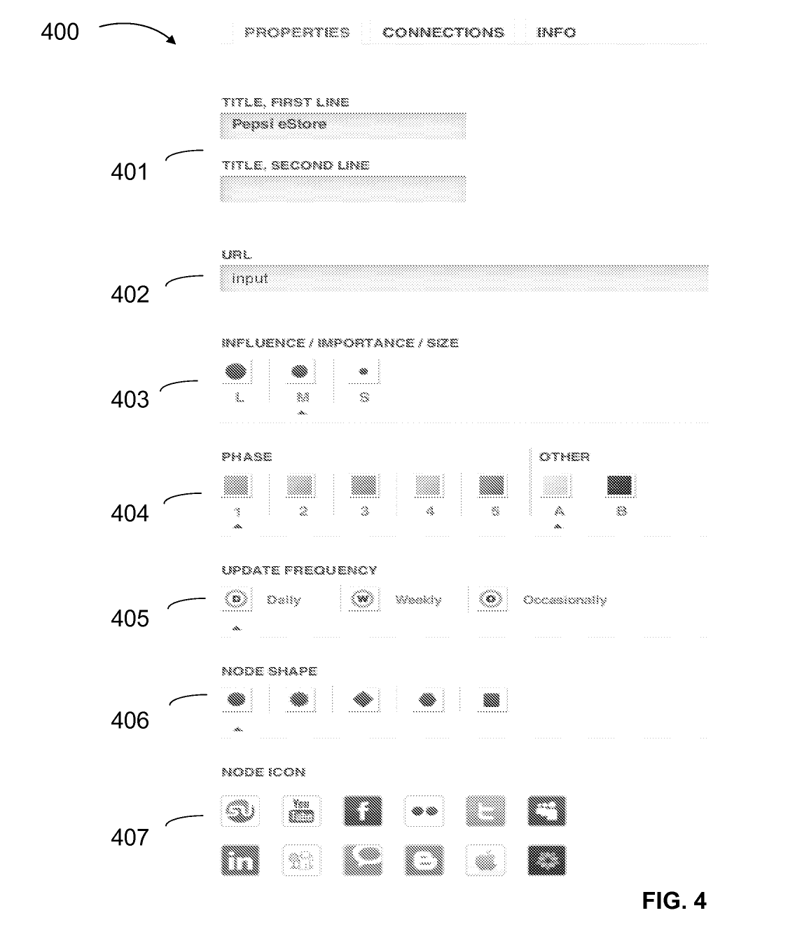

An example of a control panel 400 in accordance with an embodiment is illustrated in FIG. 4. Control panel 400 enables a user to create a node and graphically associate information therewith. In section 401, for example, the user may enter a title and/or other descriptive identifying information to be associated with the node. Using section 402, the user may, optionally, associate a URL with the node. For example, where the node represents a website, e.g., Pepsi eStore, the user may wish to enter the URL associated with that website in section 402. Using section 403 and section 404, the user may be enabled to graphically associate information with the node. For example the relative importance of nodes (which may be determined, for example, by influence, importance or size of the item, entity or venue represented by the node) may be signified by a corresponding assignment of a node size in section 403. As a further example, a temporal relationship may be signified by appropriate color coding of nodes, using tools provided in section 404. For example, marketing activities associated with any node may be designed to be carried out in planned phases and each phase may be associated with a particular color. Using section 405, the user may be enabled to select an update frequency to be associated with a node. Update frequency may relate, for example, to how frequently content at a node is to be refreshed, and/or how frequently marketing performance metrics associated with a node are to be accessed. Similarly, the user may select particular node shapes in sections 406 and 407. A particular node shape may be associated with a corresponding type of nodes. For example nodes signifying social networking sites may be represented by circles, whereas nodes signifying sales fulfillment sites may be represented by squares. Nodes signifying venues associated a trade mark, may be represented by the corresponding mark using icons selected from section 407, for example.

Referring now to FIG. 2B, an exemplary output of an embodiment will be described. A plurality of nodes 201 and a plurality of connections 202 are represented in a network 200. Advantageously, a central node, node 210, may be defined to represent, for example a control point of a marketing campaign, or a home website of product or brand to be launched. In an embodiment, the software application enables monitoring and manipulation of nodes 201 and connections 202. For example, as discussed above, a graphical user interface may be provided wherein a user may conveniently add, remove and/or change characteristics of connection 202 between two nodes 201(1) and 201(2). Connection 202 may represent a variety of relationships, selectable by the user. For example, connection 202 may represent a hyperlink between two websites. Alternately, or in addition, connection 202 may represent an organizational relationship, signifying for example that two nodes are commonly owned, or contractually related.

In an embodiment, connection 202 may be graphically represented by associating characteristics of a relationship signified by connection 202 with data such as (i) a volume of click-through traffic; (ii) a measure of financial performance; (iii) an organizational relationship between respective proprietors of connected nodes. For example, a color, style, or weighting of a connection may signify values related to one or more of the foregoing details. The measure of financial performance may, for example, be revenue, income, expense, investment, or return on investment.

In an embodiment, a node 201 may signify a general venue of a series of marketing tactics, for example, related to an online social media network, a blogsite, a virtual space, and a wiki. Such general venues may host multiple locations of interest to a marketing campaign (i.e., fan pages within a venue such as Facebook), and each such location may be represented by one or more additional nodes.

Over time, a map created with the foregoing techniques may become a vessel of institutional knowledge, and provide a secure and shared place to store information about a current and future state of a brand online.

In an embodiment, automated updates to a created map may be enabled, whereby the tool may automatically call information from other sources. For example, metrics and performance data on each node may be called from a variety of different sources such as Google, SentimentMetrics, Twitter, YouTube, Facebook, and countless others. Advantageously, these automated updates may be obtained in near real-time. For example, by using available application programming interfaces and/or other publicly or privately available information, server-side data calls may be employed to request serial updates of relevant information. Examples of relevant information might include site traffic statistics, such as the number of views of a video on YouTube, or the relative sentiment of a given keyword.

Thus, a created map may be operable as a real-time data dashboard, showing, in addition to the nodes of a brand's online presence and their relationship to one another, the performance of each node and the system as a whole. The visual and informational user environment thereby enables a user to assess the performance of a marketing network in real-time across multiple platforms based on user-selected performance measurements. These performance measurements may include, for example, metrics of click-through traffic volume, sales realizations, customer conversion or sign-up, redemption rates, time on site, etc.

Additionally, the connectivity map interface may be optimized for other interfaces, including touchscreen and mobile devices, allowing a variety of access, manipulation, and presentation capabilities.

The software application may be hosted on a remote web server accessible via http/https, or may be recorded on a computer readable medium read directly by workstation processor 102. In an embodiment, a user may be served the software application on at least one remote terminal capable of accessing the Internet.

Embodiments involve computer software and hardware, for example, in the form of servers, personal computers, personal electronic devices, and the like. Such devices and software generally execute algorithms that implement method embodiments. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the present disclosure, use of terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various embodiments may be implemented with the aid of computer-implemented processes or methods (a.k.a. programs or routines) that may be rendered in any computer language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

Embodiments may be implemented with an apparatus to perform the operations described herein. This apparatus may be specially constructed for the required purposes, or may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), flash drives, random access memories (RAMs), EPROMs, EEPROMs, magnetic or optical cards, or any other type of tangible media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct a more specialized apparatus to perform the required method. For example, any of the methods described may be implemented in hard-wired circuitry, by programming a general-purpose processor or by any combination of hardware and software. One of ordinary skill in the art will immediately appreciate that the teachings of the present disclosure may be practiced with computer system configurations other than those described below, including hand-held devices, multiprocessor systems, microprocessor-based or programmable consumer electronics, DSP devices, network PCs, minicomputers, mainframe computers, and the like, as well as in distributed computing environments where tasks are performed by remote processing devices that are linked through a communications network. The required structure for a variety of these systems will appear from the description above.

Systems and methods of managing an online marketing presence of a brand or product have been described. The foregoing description, however, merely illustrates principles and exemplary embodiments of the invention. It will thus be appreciated that those skilled in the art will be able to devise numerous systems and methods that, although not explicitly shown or described herein, embody said principles of and are thus within the spirit and scope of the following claims.

What is claimed is:

1. A method for managing an online presence of a brand or product, comprising:
representing, graphically, using a software application operable with a computerized workstation:
(i) a plurality of nodes, each of said plurality of nodes signifying at least one of (a) an instance of an online advertisement, (b) a venue wherein at least one marketing tactic is executed, (c) a representation of an advertising or marketing agency, and (d) a sales/sales fulfillment site; and
(ii) at least one connection, each said connection linking a pair of said plurality of nodes, the connection signifying an informational relationship between the pair of nodes, the informational relationship comprising at least one of a logical and a communicative relationship; wherein
said workstation comprises a processor, a memory, a display and a user input interface and the software application causes the workstation to graphically display the plurality of nodes and the at least one connection.

2. The method of claim 1, wherein the software application enables monitoring and manipulation of connections between the nodes.

3. The method of claim 1, wherein the software application is hosted on a remote webserver accessible via http/https.

4. The method of claim 3, wherein a user is served the software application on at least one remote terminal capable of accessing the Internet.

5. The method of claim 1 wherein the venue comprises at least one of an online social media network, a blogsite, a virtual space, and a wiki.

6. The method of claim 1 wherein representing graphically at least one connection comprises associating characteristics of the connection with at least one of (i) a volume of click-through traffic; (ii) a measure of financial performance; (iii) an organizational relationship between respective proprietors of connected nodes.

7. The method of claim 1 wherein representing graphically at least one connection comprises displaying collected data on marketing network performance.

8. The method of claim 7, wherein the collected data is obtained autonomously.

9. The method of claim 8, wherein the collected data is displayed in near real-time.

10. The method of claim 7, wherein the collected data is a metric of at least one of click-through traffic volume, sales realizations, customer conversion, customer sign-up, redemption rates, and time on site.

11. A system for managing an online presence of a brand or product, said system comprising:
at least one computerized workstation, said workstation comprising a processor, memory, a display and a user input interface;
a software application, operable with said workstation, comprising an interactive tool wherewith a user is enabled to graphically represent:
(i) a plurality of nodes, each of said plurality of nodes signifying at least one of (a) an instance of an online advertisement, (b) the general venue of a series of marketing tactics, (c) a representation of an advertising or marketing agency, and (d) a sales/sales fulfillment site; and
(ii) at least one connection, each said connection linking a pair of said plurality of nodes, the connection signifying an informational relationship between the pair of nodes, the informational relationship comprising at least one of a logical and a communicative relationship; and
the software application causes the workstation to graphically display the plurality of nodes and the at least one connection.

12. The system of claim 11, wherein the software application enables monitoring and manipulation of connections between the nodes.

13. The system of claim 11, wherein the software application is hosted on a remote webserver accessible via http/https.

14. The system of claim 13, wherein a user is served the software application on at least one remote terminal capable of accessing the Internet.

15. The system of claim 11 wherein the general venue of a series of marketing tactics comprises at least one of an online social media network, a blogsite, a virtual space, and a wiki.

16. The system of claim 11 wherein representing graphically at least one connection comprises associating characteristics of the connection with at least one of (i) a volume of click-through traffic; (ii) a measure of financial performance; (iii) an organizational relationship between respective proprietors of connected nodes.

17. The system of claim 11, wherein representing graphically at least one connection comprises displaying collected data on marketing network performance.

18. The system of claim 17, wherein the collected data is obtained autonomously.

19. The system of claim 18, wherein the collected data is displayed in near real-time.

20. The system of claim 17, wherein the collected data is a metric of at least one of click-through traffic volume, sales realizations, customer conversion, customer sign-up, redemption rates, and time on site.

21. A computer program product stored in a computer-readable storage medium which, when executed by a processing arrangement, is configured to manage an online presence of a brand or product, comprising:
a computer program including:
computer readable program code used to represent, graphically:
(i) a plurality of nodes, each of said plurality of nodes signifying at least one of (a) an instance of an online advertisement, (b) a general venue of a series of marketing tactics, (c) a representation of an advertising or marketing agency, and (d) a sales/sales fulfillment site, and
(ii) at least one connection, each said connection linking a pair of said plurality of nodes, the connection signifying an informational relationship between the pair of nodes, the informational relationship comprising at least one of a logical and a communicative relationship; and
computer readable program code used to cause the workstation to graphically display the plurality of nodes and the at least one connection.
